(19) United States
(12) Patent Application Publication
(10) Pub. No.: US 2013/0063330 A1
(43) Pub. Date: Mar. 14, 2013

(54) Organic Light-Emitting Display Device

(71) Applicant: Ki-Myeong Eom, Yongin-City (KR)

(72) Inventor: Ki-Myeong Eom, Yongin-City (KR)

(73) Assignee: SAMSUNG MOBILE DISPLAY CO., LTD., Yongin-City (KR)

(21) Appl. No.: 13/415,630

(22) Filed: Mar. 8, 2012

(30) Foreign Application Priority Data
Sep. 8, 2011 (KR) 10-2011-0091323

(51) Int. Cl. G09G 3/32

(52) U.S. Cl. 345/80

(57) ABSTRACT

An organic light-emitting display device which may widen a swing range of a green sub-pixel. In the organic light-emitting display device, from among red, green, and blue sub-pixels, an overlapping area of material layers forming a thin film transistor, a boost capacitor and/or a storage capacitor of the green sub-pixel is greater than an overlapping area of the same material layers forming a thin film transistor, a boost capacitor and/or a storage capacitor of the red and blue sub-pixels. Accordingly, since a swing range of the green sub-pixel having relatively high light-emitting efficiency is widened, more accurate gradation may be displayed, a reliable product may be realized, a brightness variation of the organic light-emitting display device may be reduced, and the risk of poor image quality may be reduced.

### CLAIM OF PRIORITY

this application makes reference to, incorporates the same herein, and claims all benefits accruing under 35 U.S.C. §119 from an application earlier filed in the Korean Intellectual Property Office on the 8 Sep. 2011 and there duly assigned Serial No. 10-2011-0091323.

### BACKGROUND OF THE INVENTION

1. Field of the Invention

The present invention relates to an organic light-emitting display device, and more particularly, to an organic light-emitting display device including three sub-pixels constituting a unit pixel.

2. Description of the Related Art

In general, a unit pixel of an organic light-emitting display device includes a red sub-pixel, a green sub-pixel, and a blue sub-pixel, and a desired color is achieved by combining the colors of the three sub-pixels.

Each of the three sub-pixels includes a thin film transistor, a capacitor, and a light-emitting unit connected to the thin film transistor and the capacitor. The light-emitting unit receives an appropriate driving signal from the thin film transistor and the capacitor to emit light and display a desired image.

From among the red, green, and blue sub-pixels, the green sub-pixel has the highest light-emitting efficiency. Accordingly, when the three sub-pixels are formed to have the same size as in a conventional method, less current flows through the green sub-pixel. That is, since a sub-pixel having higher efficiency than other sub-pixels has the same brightness with less current than the other sub-pixels, less current flows through the green sub-pixel in order for the three sub-pixels to have the same brightness. In this case, however, since a swing range for displaying gradation is narrowed in the green sub-pixel, more precise control is needed. For example, if gradation having 256 levels is displayed, since the green sub-pixel displays 256 levels with relatively small current, a voltage control range for displaying overall gradation is narrowed in the green sub-pixel compared to that in the other sub-pixels and a voltage difference in one gradation is reduced, thereby making it difficult to control. Accordingly, once the swing range is narrowed, gradation is not accurately displayed even with a slight deviation, thereby increasing a brightness variation. Accordingly, there is demand for a solution to this problem.

### SUMMARY OF THE INVENTION

The present invention provides an organic light-emitting display device which may prevent a swing range of a green sub-pixel from being narrowed due to efficiency difference between sub-pixels having different colors.

According to an aspect of the present invention, there is provided an organic light-emitting display device including red, green, and blue sub-pixels which emit light having different colors and each of which includes a thin film transistor and a capacitor, wherein a size of the thin film transistor of the green sub-pixel is greater than a size of each of the thin film transistors of the red and blue sub-pixels.

The thin film transistor may include an active layer and a gate electrode, wherein a width of an overlapping region between the active layer and the gate electrode of the green sub-pixel is less than a width of an overlapping region between the active layer and the gate electrode of each of the red and blue sub-pixels.

A length of the overlapping region between the active layer and the gate electrode of the green sub-pixel may be greater than a length of the overlapping region between the active layer and the gate electrode of each of the red and blue sub-pixels.

A width to length ratio of each of the red sub-pixel and the blue sub-pixel may range from 4:20 to 5:20, and a width to length ratio of the green sub-pixel may range from 3:30 to 4:30.

In the overlapping region, the gate electrode may have a rectangular shape, and the active layer may have a T-shape.

The capacitor may include a storage capacitor and a boost capacitor.

Areas of the storage capacitor and the boost capacitor of the green sub-pixel may be greater than areas of the storage capacitor and the boost capacitor of each of the red and blue sub-pixels.

The storage capacitor may include a first storage electrode, which is formed from the same layer as the active layer, and a second storage electrode, which is formed from the same layer as the gate electrode, wherein an overlapping region between the first and second storage electrodes of the green sub-pixel is greater than an overlapping region between the first and second storage electrodes of each of the red and blue sub-pixels.

A plurality of holes may be formed in the first storage electrode.

The boost capacitor may include a first boost electrode, which is formed from the same layer as the active layer, and a second boost electrode, which is formed from the same layer as the gate electrode, wherein an overlapping region between the first and second boost electrodes of the green sub-pixel is greater than an overlapping region between the first and second boost electrodes of each of the red and blue sub-pixels.

The thin film transistor may be a driving transistor.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a plan view illustrating a unit pixel included in an organic light-emitting display device according to an embodiment of the present invention;

FIGS. 2A and 2B are plan views illustrating different layers on which elements of the unit pixel of FIG. 1 are formed;

FIG. 3A is an enlarged plan view illustrating thin film transistors of the red and green sub-pixels of FIG. 1;

FIG. 3B is an enlarged plan view illustrating boost capacitors of the red and green sub-pixels of FIG. 1;

FIG. 3C is an enlarged plan view illustrating storage capacitors of the red and green sub-pixels of FIG. 1;

FIG. 4 is a cross-sectional view taken along line A-A of FIG. 1;

FIG. 5 is a plan view illustrating a unit pixel included in an organic light-emitting display device according to another embodiment of the present invention; and

FIG. 6 is a plan view illustrating a modifiable example of the thin film transistors of FIG. 3A.

### DETAILED DESCRIPTION OF THE INVENTION

The present invention will now be described more fully with reference to the accompanying drawings, in which exemplary embodiments of the invention are shown.

In the drawings, the same reference numerals denote the same elements. In the description of the present invention, certain detailed explanations of related art are omitted when it is deemed that they may unnecessarily obscure the essence of the invention.

In the drawings, thicknesses of layers or regions may be exaggerated for clarity. Also, it will be understood that when an element, such as a layer, a film, a region, or a plate, is referred to as being “on”, “connected to” or “coupled to” another element, it may be directly on, connected or coupled to the other element or intervening elements may be present.

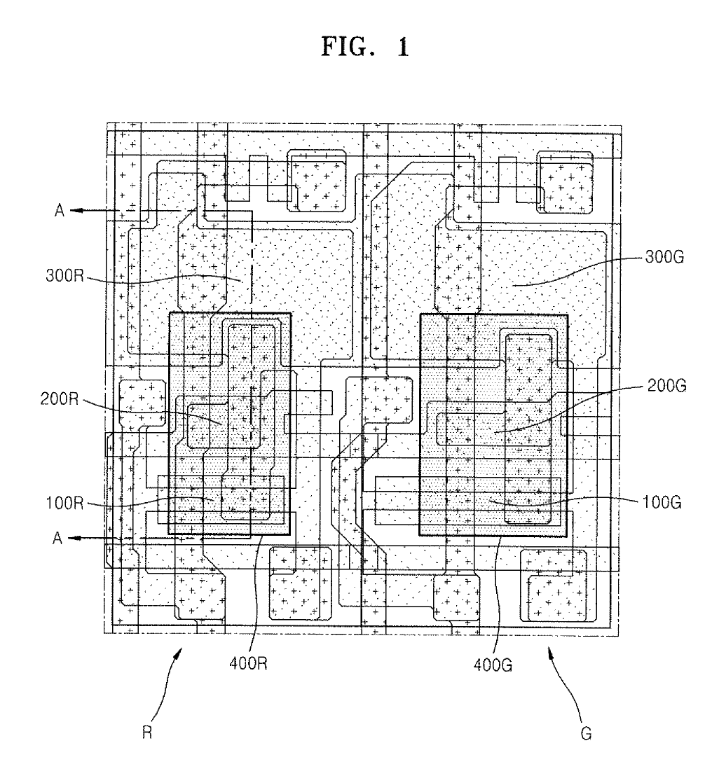

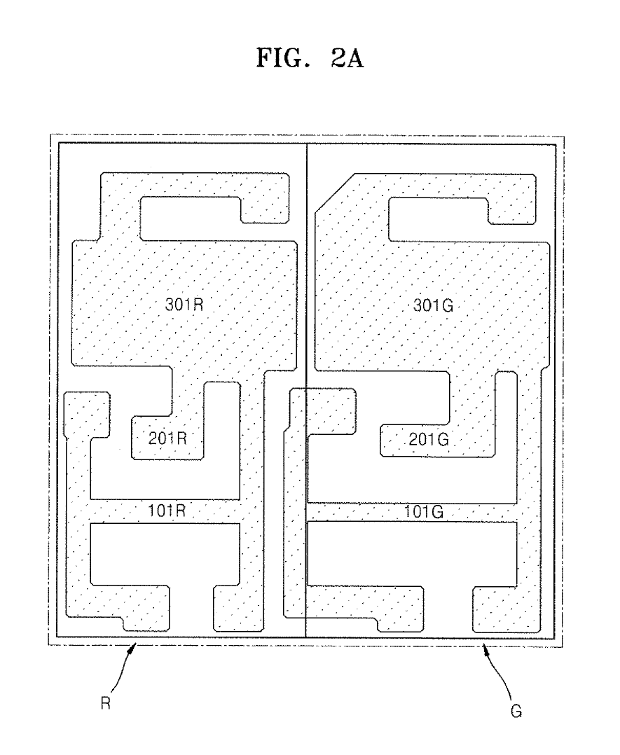

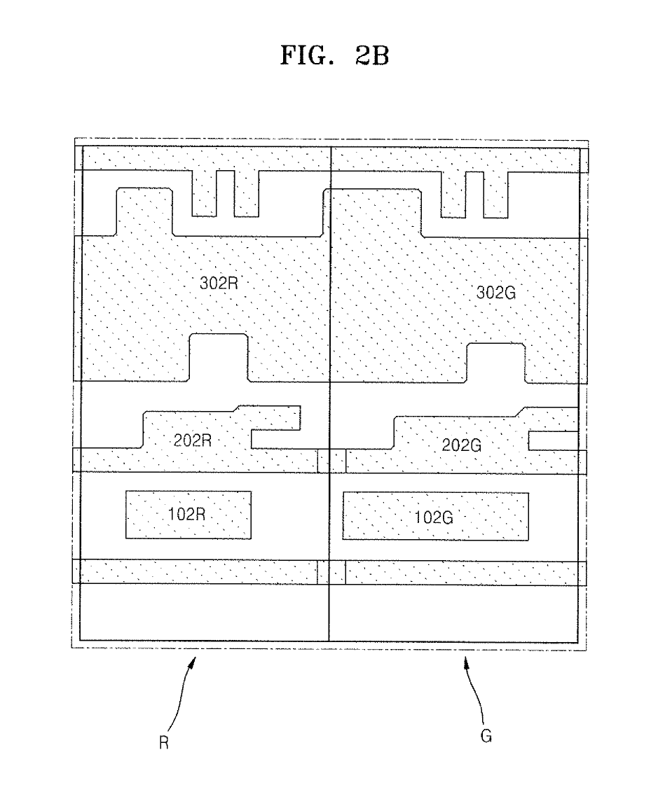

FIG. 1 is a plan view illustrating a unit pixel included in an organic light-emitting display device according to an embodiment of the present invention. FIGS. 2A and 2B are plan views illustrating different layers on which elements of the unit pixel of FIG. 1 are formed. The unit pixel includes three sub-pixels, that is, a red sub-pixel R, a green sub-pixel G, and a blue sub-pixel (not shown). Since the blue sub-pixel and the red sub-pixel R have the same structure in the present embodiment, both are not shown but only the red sub-pixel R is shown in order to be easily compared with the green sub-pixel G. In the organic light-emitting display device, a plurality of the unit pixels each including the three sub-pixels are repeatedly arranged in rows and columns.

Referring to FIG. 1, in the organic light-emitting display device, the three sub-pixels, that is, the red sub-pixel R, the green sub-pixel G, and the blue sub-pixel (not shown), constitute each unit pixel as described above. The blue sub-pixel has the same structure as the red sub-pixel R, and a description of the structure of the red sub-pixel R below applies for the blue sub-pixel.

First, the red sub-pixel R and the green sub-pixel G respectively include light-emitting units 400R and 400G, thin film transistors 100R and 100G, storage capacitors 300R and 300G, and boost capacitors 200R and 200G. Accordingly, when current flows through the thin film transistors 100R and 100G, the storage capacitors 300R and 300G, and the boost capacitors 200R and 200G, the light-emitting units 400R and 400G connected to the thin film transistors 100R and 100G, the storage capacitors 300R and 300G, and the boost capacitors 200R and 200G emit light to thus form an image. The thin film transistors 100R and 100G are driving transistors for driving the light-emitting units 400R and 400G, respectively.

Since the green sub-pixel G has relatively high light-emitting efficiency as described above, if the green sub-pixel G is formed to have the same structure as that of the red sub-pixel R and the blue sub-pixel, current used to emit light is reduced and a swing range is reduced, thereby making it difficult to precisely display gradation.

Accordingly, in order to avoid this problem, in the present embodiment, the thin film transistors 100R and 100G, the storage capacitors 300R and 300G, and the boost capacitors 200R and 200G which are connected to the light-emitting units 400R and 400G are formed to have different sizes.

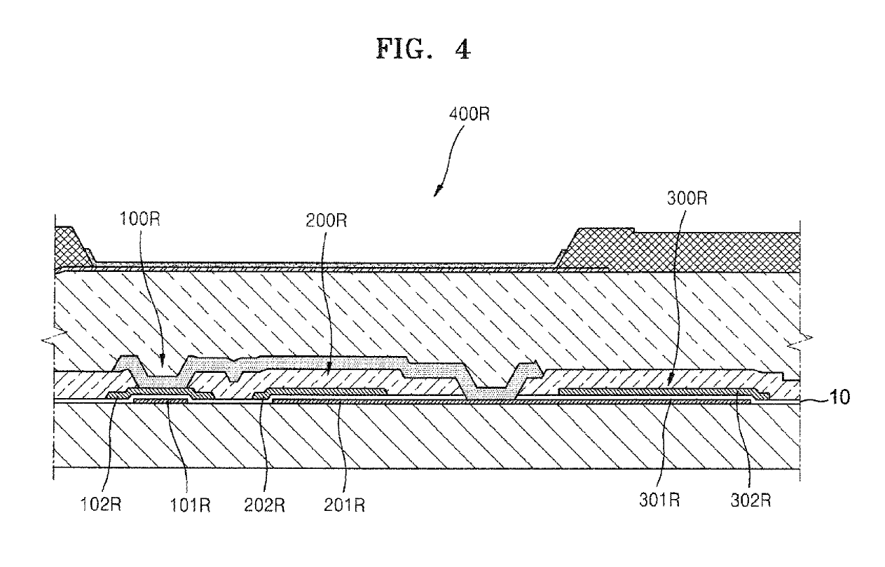

In detail, the structure of the red sub-pixel R will be explained as follows with reference to FIG. 4. FIG. 4 is a cross-sectional view taken along line A-A of FIG. 1. The blue sub-pixel (not shown) has the same structure as that of the red sub-pixel R described above, and the green sub-pixel G has substantially the same structure as that of the red sub-pixel R although there is a difference in size between the green sub-pixel G and the red sub-pixel R. Referring to FIG. 4, the thin film transistor 100R, the storage capacitor 300R, and the boost capacitor 200R which are connected to the light-emitting unit 400R are formed under the light-emitting unit 400R. An active layer 101R and a gate electrode 102R, a first storage electrode 301R and a second storage electrode 302R, and a first boost electrode 201R and a second boost electrode 202R face each other with an insulating layer 10 therebetween.

The active layer 101R, the first storage electrode 301R, and the first boost electrode 201R are formed from a same material layer, and the gate electrode 102R, the second storage electrode 302R, and the second boost electrode 202R are formed from a same material layer, as shown in FIGS. 2A and 2B.

That is, the active layers 101R and 101G, the first storage electrodes 301R and 301G, and the first boost electrodes 201R and 201G of the red and green sub-pixels R and G are formed from a same material layer as shown in FIG. 2A, and the gate electrodes 102R and 102G, the second storage electrodes 302R and 302G, and the second boost electrodes 202R and 202G are formed from a same material layer as shown in FIG. 2B.

Structures of FIGS. 2A and 2B are stacked with the insulating layer 10 (FIG. 4) therebetween to form an overlapping region. The thin film transistors 100R and 100G, the storage capacitors 300R and 300G, and the boost capacitors 200R and 200G are formed in the overlapping region.

Elements of the red sub-pixel R and the green sub-pixel G will be compared with each other.

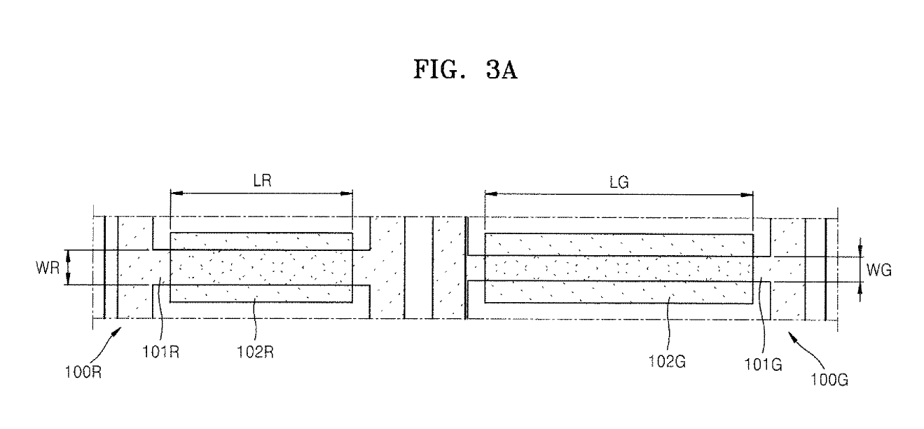

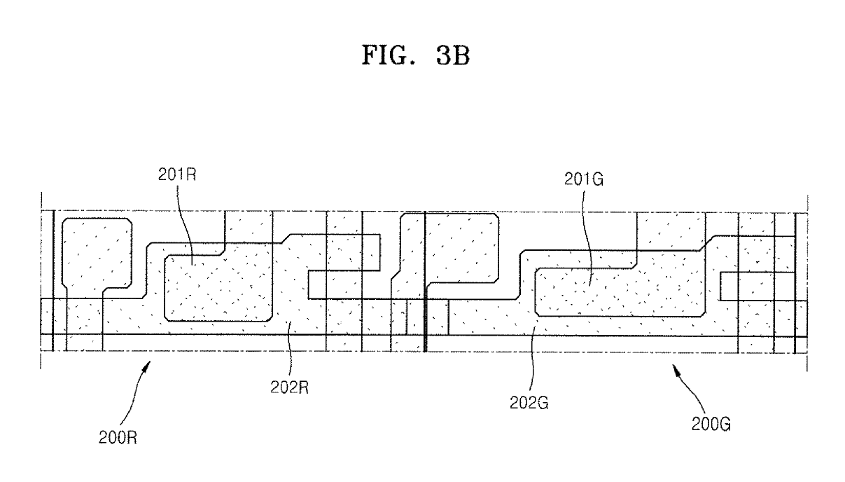

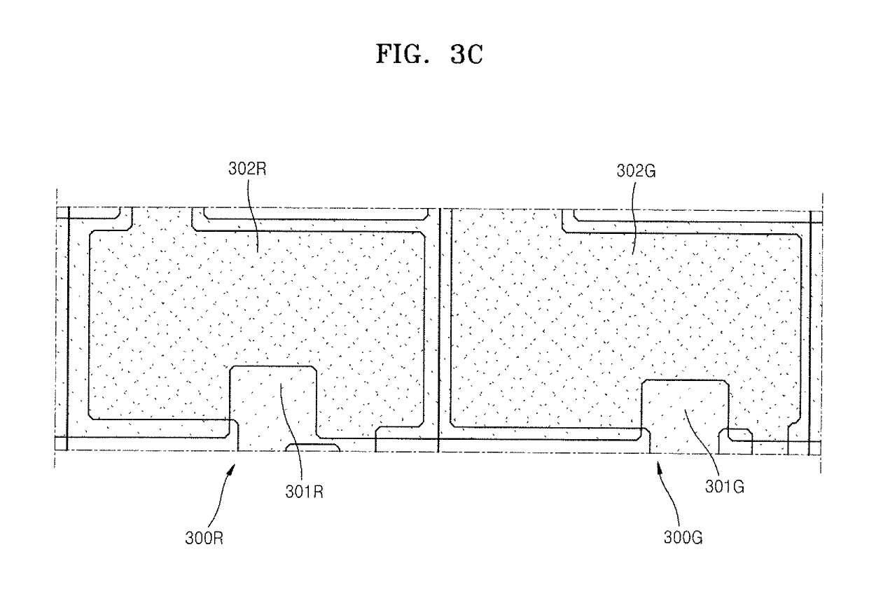

FIG. 3A is an enlarged plan view illustrating the thin film transistors 100R and 100G of the red and green sub-pixels R and G of FIG. 1. FIG. 3B is an enlarged plan view illustrating the boost capacitors 200R and 200G of the red and green sub-pixels R and G of FIG. 1. FIG. 3C is an enlarged plan view illustrating the storage capacitors 300R and 300G of the red and green sub-pixels R and G of FIG. 1.

Referring to FIG. 3A, the thin film transistors 100R and 100G are respectively formed in overlapping regions between the active layers 101R and 101G and the gate electrodes 102R and 102G. When the overlapping regions are compared with each other, a width of the overlapping region of the green sub-pixel G is less than a width of the overlapping region of the red sub-pixel R (WG<WR), and a length of the overlapping region of the green sub-pixel G is greater than a length of the overlapping region of the red sub-pixel R (LG>LR). A total area of the overlapping region of the green sub-pixel G is greater than a total area of the overlapping region of the red sub-pixel R. In detail, if a width (WR) to length (LR) ratio of the overlapping region of the red sub-pixel R ranges from 4:20 (μm) to 5:20 (μm), a width (WG) to length (LG) ratio of the green sub-pixel G may range from 3:30 (μm) to 4:30 (μm).

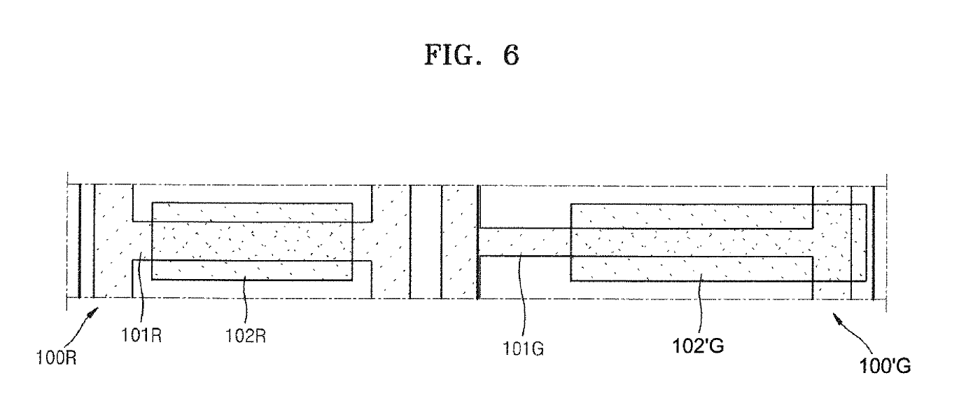

FIG. 6 is a plan view illustrating a modified example of FIG. 3A. The gate electrode 102′G of the green sub-pixel G may be formed to overlap with a T-shaped portion of the active layer 101G. In this case, a length of the thin film transistor 100′G is greater than a length of the thin film transistor 100R of the red sub-pixel R.

If a width of the thin film transistor 100′G is reduced and a length of the thin film transistor 100′G is increased, the amount of current supplied to emit light with a desired brightness is increased. Accordingly, a swing range for displaying overall gradation is increased and a voltage range corresponding to one gradation is widened, thereby making it easy to precisely display gradation. According to experiments, when a width to length ratio is 5:20, a swing range is 1.5 V, and when a width to length ratio is 4:30, a swing range is 1.7 V, which is higher by about 0.2 V than 1.5 V. Accordingly, when gradation having 256 levels is displayed, a voltage difference in one gradation is increased from 5.86 mV to 6.64 mV, thereby making it easy to control.

Also, since the storage capacitors 300R and 300G and the boost capacitors 200R and 200G affect gradation display of the light-emitting units 400R and 400G in the present embodiment, the storage capacitor 300G (FIG. 3C) and the boost capacitor 200G (FIG. 3B) of the green sub-pixel G may be greater in size than the storage capacitor 300R and the boost capacitor 200R of the red sub-pixel R.

That is, referring to FIG. 3B, the boost capacitors 200R and 200G are formed in overlapping regions between the first boost electrodes 201R and 201G and the second boost electrodes 202R and 202G, and an area of the overlapping region of the green sub-pixel G is greater than an area of the overlapping region of the red sub-pixel R. Accordingly, the amount of current supplied in order for the light-emitting unit 400G to emit light with a desired brightness is increased and a swing range for displaying overall gradation is increased, thereby making it easy to precisely display gradation.

Likewise, referring to FIG. 3C, the storage capacitors 300R and 300G are formed in overlapping regions between the first storage electrodes 301R and 301G and the second storage electrodes 302R and 302G. An area of the overlapping region of the green sub-pixel G is greater than an area of the overlapping region of the red sub-pixel R. Accordingly, the amount of current supplied in order for the light-emitting unit 400G to emit light with a desired brightness is increased and a swing range for displaying overall gradation is increased, thereby making it easy to precisely display gradation.

Since the organic light-emitting display device including the unit pixel as described above achieves a wide swing range by allowing the thin film transistor 100G, the storage capacitor 300G, or the boost capacitor 200G of the green sub-pixel G having relatively high light-emitting efficiency to be greater in size than that of the red sub-pixel R or the blue sub-pixel (not shown), precise gradation display may be easily controlled, and thus a highly reliable product having more accurate gradation display may be realized. Also, since a brightness variation of the organic light-emitting display device is reduced, the risk of poor image quality may be reduced.

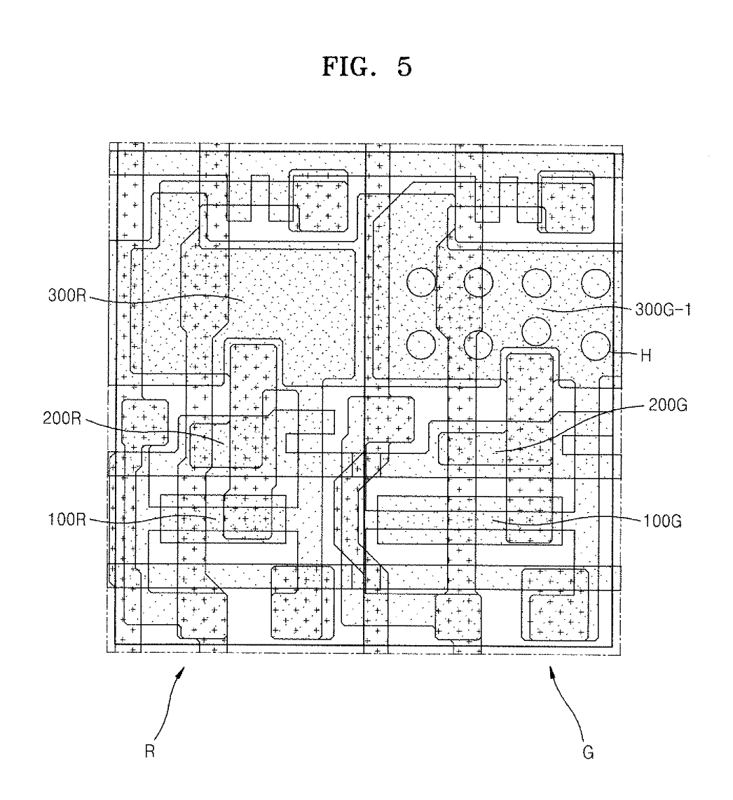

FIG. 5 is a plan view illustrating a unit pixel included in an organic light-emitting display device according to another embodiment of the present invention. Referring to FIG. 5, a plurality of holes H are formed in one of the first or second storage electrodes of a storage capacitor 300G-1 of the green sub-pixel G. That is, when the plurality of holes H are formed in, for example, the second storage electrode, as shown, of the storage capacitor 300G-1 of the green sub-pixel G, an area difference between the storage capacitor 300G-1 and the boost capacitor 200G is reduced. Accordingly, even when a skew, which makes it difficult to precisely pattern the storage capacitor 300G-1 and the boost capacitor 200G, occurs, an extent to which an area difference between the storage capacitor 300G-1 and the boost capacitor 200G is increased may be reduced. As such, additional modifications for achieving various other effects may be made within the scope of the present invention.

As described above, according to an organic light-emitting display device of the present invention, since sizes of a thin film transistor and a capacitor of a sub-pixel having relatively high light-emitting efficiency are greater than sizes of a thin film transistor and a capacitor of each of other sub-pixels to narrow a swing range, gradation display may be easily controlled, a brightness variation of the organic light-emitting display device may be reduced, and the risk of poor image quality may be reduced.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. An organic light-emitting display device comprising sub-pixels which emit light of different colors, each sub-pixel comprising a thin film transistor and a capacitor, a size of the thin film transistor of the sub-pixel emitting light of a first color being greater than a size of the thin film transistor of the sub-pixel emitting light of a second color.

2. The organic light-emitting display device of claim 1, the first color being green.

3. The organic light-emitting display device of claim 1, each thin film transistor comprising an overlapping area including an active layer and a gate electrode, a width of the overlapping area of the thin film transistor of the sub-pixel emitting light of the first color being less than a width of the overlapping area of the thin film transistor of the sub-pixel emitting light of the second color.

4. The organic light-emitting display device of claim 3, a length of the overlapping area of the thin film transistor of the sub-pixel emitting light of the first color being greater than a length of the overlapping area of the thin film transistor of the sub-pixel emitting light of the second color.

5. The organic light-emitting display device of claim 4, wherein a width to length ratio of the sub-pixel emitting light of the second color ranges from 4:20 to 5:20, and a width to length ratio of the sub-pixel emitting light of the first color ranges from 3:30 to 4:30.

6. The organic light-emitting display device of claim 3, in the overlapping area of the thin film transistor of the sub-pixel emitting light of the first color, the gate electrode has a rectangular shape, and the active layer has a T-shape.

7. The organic light-emitting display device of claim 3, the capacitor comprising a storage capacitor and a boost capacitor.

8. The organic light-emitting display device of claim 7, an overlapping area of material layers forming the storage capacitor and the boost capacitor of the sub-pixel emitting light of the first color being greater than an overlapping area of material layers forming the storage capacitor and the boost capacitor of the sub-pixel emitting light of the second color.

9. The organic light-emitting display device of claim 8, the overlapping area of the material layers forming the storage capacitor comprising first and second storage electrodes and the overlapping area of the material layers forming the boost capacitor comprising first and second boost electrodes, the active layer, the first storage electrode and the first boost electrode being simultaneously formed by a first material layer, and the gate electrode, the second storage electrode and the second boost electrode being simultaneously formed by a second material layer.

10. The organic light-emitting display device of claim 9, further comprising a plurality of holes formed in one of the first or second storage electrodes of the storage capacitor of the sub-pixel emitting light of the first color.

11. The organic light-emitting display device of claim 1, wherein the thin film transistor is a driving transistor.

12. The organic light-emitting display device of claim 9, further comprising an insulating layer formed between the first material layer and the second material layer.

13. The organic light-emitting display device of claim 9, the first color being green.

14. An organic light-emitting display device comprising a red sub-pixel and a green sub-pixel, each of the red and green sub-pixels comprising a thin film transistor and a capacitor, a size of the thin film transistor of the green sub-pixel being greater than a size of the thin film transistor of the red sub-pixel.

15. The organic light-emitting display device of claim 14, each thin film transistor comprising an overlapping area including an active layer and a gate electrode, a width of the overlapping area of the thin film transistor of the green sub-pixel being less than a width of the overlapping area of the thin film transistor of the red sub-pixel.

16. The organic light-emitting display device of claim 15, a length of the overlapping area of the thin film transistor of the green sub-pixel being greater than a length of the overlapping area of the thin film transistor of the red sub-pixel.

17. The organic light-emitting display device of claim 16, wherein a width to length ratio of the red sub-pixel ranges from 4:20 to 5:20, and a width to length ratio of the green sub-pixel ranges from 3:30 to 4:30.

18. The organic light-emitting display device of claim 15, the capacitor comprising a storage capacitor and a boost capacitor, and an overlapping area of material layers forming the storage capacitor and the boost capacitor of the green sub-pixel being greater than an overlapping area of material layers forming the storage capacitor and the boost capacitor of the red sub-pixel.

19. The organic light-emitting display device of claim 18, the overlapping area of the material layers forming the storage capacitor comprising first and second storage electrodes and the overlapping area of the material layers forming the boost capacitor comprising first and second boost electrodes, the active layer, the first storage electrode and the first boost electrode being simultaneously formed by a first material layer, and the gate electrode, the second storage electrode and the second boost electrode being simultaneously formed by a second material layer.

20. The organic light-emitting display device of claim 19, further comprising a plurality of holes formed in one of the first or second storage electrodes of the storage capacitor of the green sub-pixel.
